(19) United States
(12) Patent Application Publication
(10) Pub. No.: US 2009/0020929 A1
(43) Pub. Date: Jan. 22, 2009

(54) Strut Top Mount With Axial Hydraulic Element

(75) Inventors: Todd M. Wirges, Ann Arbor, MI (US); Tyler K. Boger, Novi, MI (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: FREUDENBERG-NOK GENERAL PARTNERSHIP, Plymouth, MI (US)

(21) Appl. No.: 11/779,612

(22) Filed: Jul. 18, 2007

(51) Int. Cl. F16F 5/00

(52) U.S. Cl. 267/136

(57) ABSTRACT

A hydraulic element for use in vehicle mount applications includes a housing, a spring assembly disposed within the housing, and an external component outside of the housing. A first chamber is defined between the spring assembly and the housing. Furthermore, a second chamber is defined within the external component and is in fluid communication with the first chamber. With the external component providing the second chamber outside of the housing, the hydraulic element can be formed with a relatively compact configuration.

### FIELD

The present disclosure relates to mounts and mount assemblies for use in vehicles, especially mounts including a hydraulic element.

### BACKGROUND

The statements in this section merely provide background information related to the present disclosure and may not constitute prior art.

It is known to use hydraulic elements as mounts or in mount assemblies for a vehicle, e.g., in suspension mount and engine mount applications. Furthermore, many typical mount applications of hydraulic elements place a premium on height of the mount or assembly. For example, space can be limited by engine block and vehicle frame interfaces. Accordingly, it would be desirable to have a hydraulic element providing conventional functionality with a compact configuration.

### SUMMARY

The present disclosure provides a hydraulic element for a vehicle mount assembly. The hydraulic element includes a housing adapted to be coupled between members of a vehicle and a spring assembly disposed within the housing. The spring assembly engages the housing so as to define a first chamber between the spring assembly and the housing. The hydraulic element further includes an external component disposed outside of the housing. The external component defines a second chamber therein, the second chamber being in fluid communication with the first chamber.

The present disclosure further provides a mount assembly. The mount assembly includes a housing, a first member fixed to the housing, and a spring assembly disposed within the housing. The spring assembly engages the housing so as to define a first chamber between the spring assembly and the housing. The mount assembly further includes a second member fixed to the spring assembly opposite the first chamber, the second member extending through the housing. Additionally, the mount assembly includes an external component disposed outside of the housing. The external component defines a second chamber therein, and the second chamber is in fluid communication with the first chamber.

The present disclosure also provides a vehicle suspension assembly. The vehicle suspension assembly includes a vehicle frame adapted to support a body of a vehicle, a strut top mount secured to the vehicle frame, a rod segment secured to the strut top mount, a strut rod adapted to be coupled to a vehicle suspension system, and a hydraulic element coupled between the rod segment and the strut rod. The hydraulic element includes a housing fixed to the rod segment and a spring assembly disposed within the housing. The spring assembly engages the housing so as to define a first chamber between the spring assembly and the housing. Furthermore, the strut rod is fixed to the spring assembly opposite the first chamber, and the strut rod extends through the housing. Additionally, the hydraulic element includes an external component disposed outside of the housing. The external component defines a second chamber therein, and the second chamber is in fluid communication with the first chamber.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic illustration of a hydraulic element according to the principles of the present disclosure;

FIG. 2 is a cross sectional view of a hydraulic element according to the principles of the present disclosure;

FIG. 3 is a perspective view of a hydraulic element according to the principles of the present disclosure;

FIG. 4 is a cross sectional view of a strut assembly including a hydraulic element according to the principles of the present disclosure; and

FIG. 5 is a portion of the cross sectional view of FIG. 4.

### DETAILED DESCRIPTION

The following description is merely exemplary in nature and is not intended to limit the present disclosure, application, or uses. It should be understood that throughout the drawings, corresponding reference numerals indicate like or corresponding parts and features.

According to the principles of the present disclosure, a hydraulic element for use in vehicle mount applications includes a housing, a spring assembly disposed within the housing, and an external component outside of the housing. A first chamber is defined between the spring assembly and the housing. Furthermore, a second chamber is defined within the external component and is in fluid communication with the first chamber. With the external component providing the second chamber outside of the housing, the hydraulic element can be formed with a relatively compact configuration.

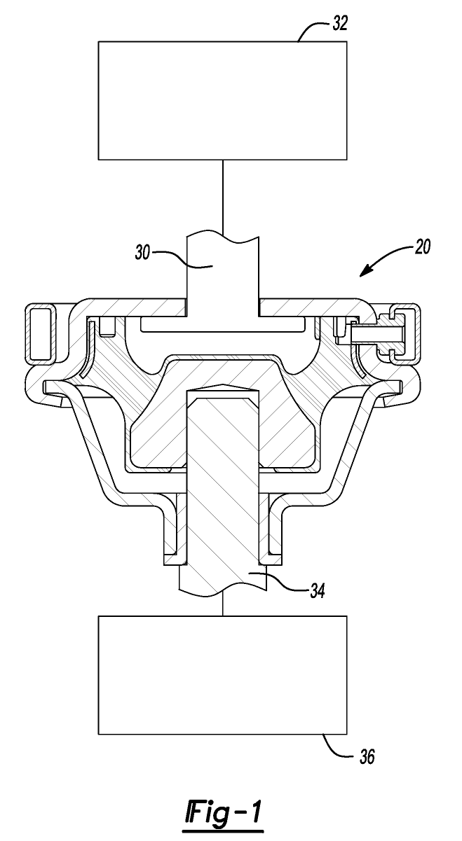

Referring to FIG. 1, a hydraulic element 20 according to the principles of the present disclosure is schematically illustrated. Hydraulic element 20 is secured to a first member 30, which is coupled to a first vehicle sub-assembly 32, and a second member 34, which is coupled to a second vehicle sub-assembly 36. Hydraulic element 20 provides vibration absorbing functionality as it is coupled in series for transmitting forces between vehicle sub-assemblies 32, 36. For example, hydraulic element 20 can provide relatively low amplitude hydraulic damping and dynamic stiffness between vehicle sub-assemblies 32, 36.

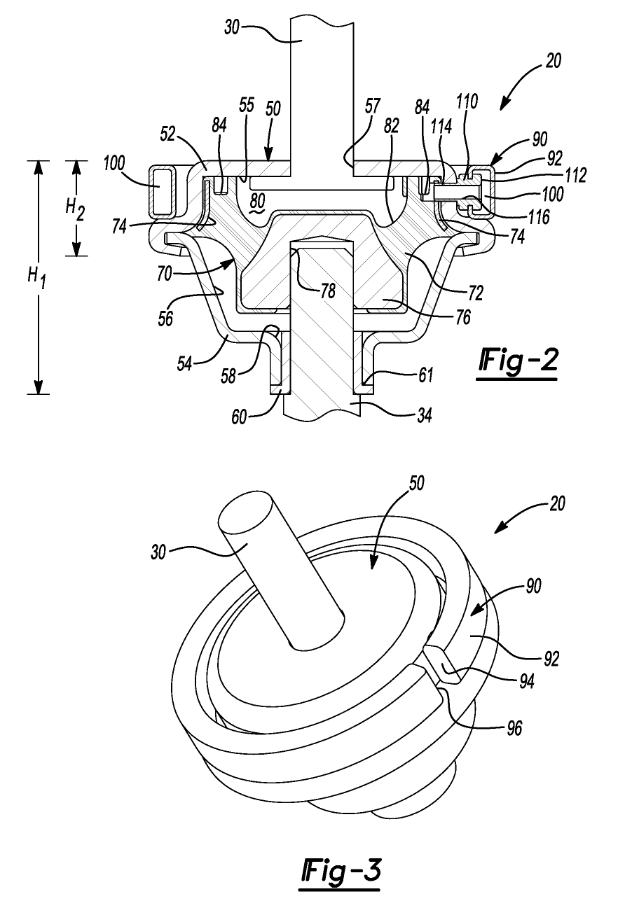

Referring to FIGS. 2-3, hydraulic element 20 is shown in detail. Hydraulic element 20 has a housing 50 which includes a first housing component 52 and a second housing component 54 secured to each other. In particular, first and second housing components 52, 54 have generally concave inner surfaces 55, 56, respectively, and first and second housing components 52, 54 are oriented such that inner surfaces 55, 56 face each other. Furthermore, first member 30 extends through an aperture 57 in first housing component 52 and is fixed thereto. Second housing component 54 includes an aperture 58 therein, and a bushing 60 is secured in aperture 58. Second member 34 extends through bushing 60 and includes a shoulder 61 that is disposed against the bushing 60.

Hydraulic element 20 further includes a spring assembly 70 disposed within housing 50. Spring assembly 70 has a main body 72 made of, e.g., an elastomeric material such as rubber. Main body 72 has a generally annular shape complementary to inner surface 55 of first housing component 52. Furthermore, an annular insert 74 is disposed in the outer portion of main body 72. Insert 74 has a generally cylindrical shape and is relatively rigid to help support spring assembly 70. Additionally, second member 34 is fixed to a relatively rigid coupling component 76 disposed in spring assembly 70. In particular, coupling component 76 defines a recess 78 which receives an end of second member 34.

Spring assembly 70 engages housing 50 and defines a first chamber 80 therebetween. In particular, main body 72 of spring assembly 70 engages inner surface 55 of first housing component 52 such that first chamber 80 is defined between a concave portion 82 of main body 72 and inner surface 55. As described in more detail herein, first chamber 80 is filled with a fluid (not shown) and functions as a pumping chamber in the operation of hydraulic element 20. Furthermore, main body 72 also includes an inertia track 84 defined therein. Inertia track 84 is in fluid communication with first chamber 80 and provides for displacement of fluid from first chamber 80, as described in more detail herein. Concave portion 82 and inertia track 84 can be molded into main body 72.

Hydraulic element 20 also includes an external component 90 disposed outside of housing 50. External component 90 has a generally annular shape defined by a body portion 92 extending around housing 50. With particular reference to FIG. 3, first and second ends 94, 96 of body portion 92 are disposed proximate each other to provide external component with the annular shape. Additionally, referring again to FIGS. 2-3, body portion 92 of external component 90 is hollow so as to define a second chamber 100 therein. As described in more detail below, second chamber 100 functions as a compensation chamber in the operation of hydraulic element 20. External component 90 can include a variety of materials, such as an elastomeric material supported by a relatively rigid insert or inserts, by way of non-limiting example.

External component 90 is coupled to the other components of hydraulic element 20 with a coupling member 110. Coupling member 110 has a first end 112 which extends into external component 90 and is secured thereto and a second end 114 which extends into housing 50 and is secured thereto. Furthermore, coupling member 110 has a channel 116 extending between first and second ends 112, 114. Channel 116 is in fluid communication with inertia track 84 and second chamber 100. As such, inertia track 84 and channel 116, in combination, provide for fluid communication between first and second chambers 80, 100 during the operation of hydraulic element 20.

According to the principles of the present disclosure, hydraulic element 20 has a conventional functionality well known to those of ordinary skill in the art. In particular, first chamber 80 is filled with fluid (not shown) and functions as a pumping chamber. Therefore, when spring assembly 70 is displaced, the fluid is forced out of first chamber 80. In particular, fluid travels from first chamber 80 through a small passage in and through inertia track 84 and through channel 11 6 and into second chamber 100, which functions as a compensation chamber that elastically deforms.

In typical hydraulic elements, compensation chambers are located in line with the other components. However, with external component 90 providing second chamber 100 outside of housing 50, hydraulic element 20 has a relatively compact size. In particular, as shown in FIG. 2, the size of hydraulic element 20 can be limited to a height H₁ defined by housing 50, as external component 90 can be disposed adjacent housing 50 in a region bound by height H₁. More particularly, hydraulic element 20 can be disposed in a region bound by a height H₂ of first housing component 52. The compact configuration allows for flexible positioning and for a broad range of applications of hydraulic element 20.

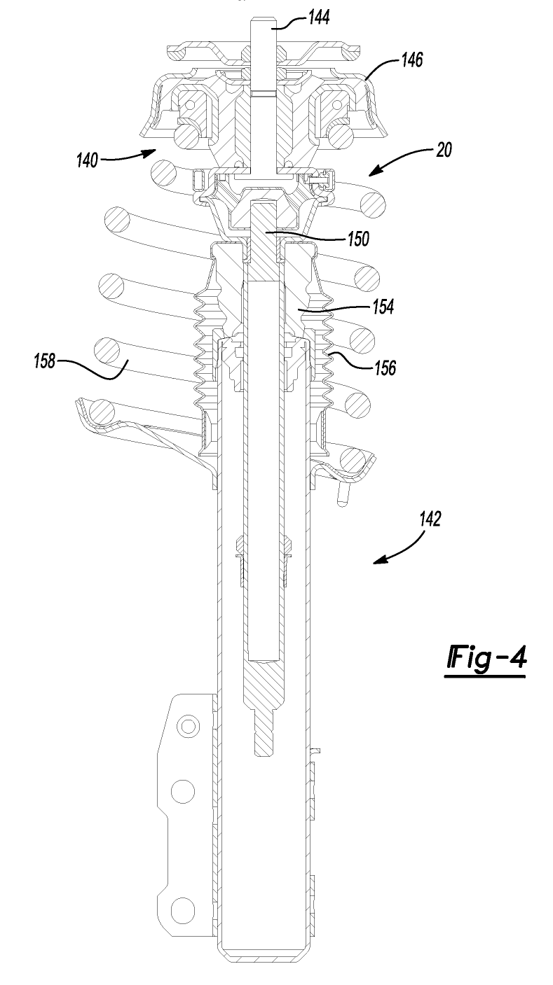

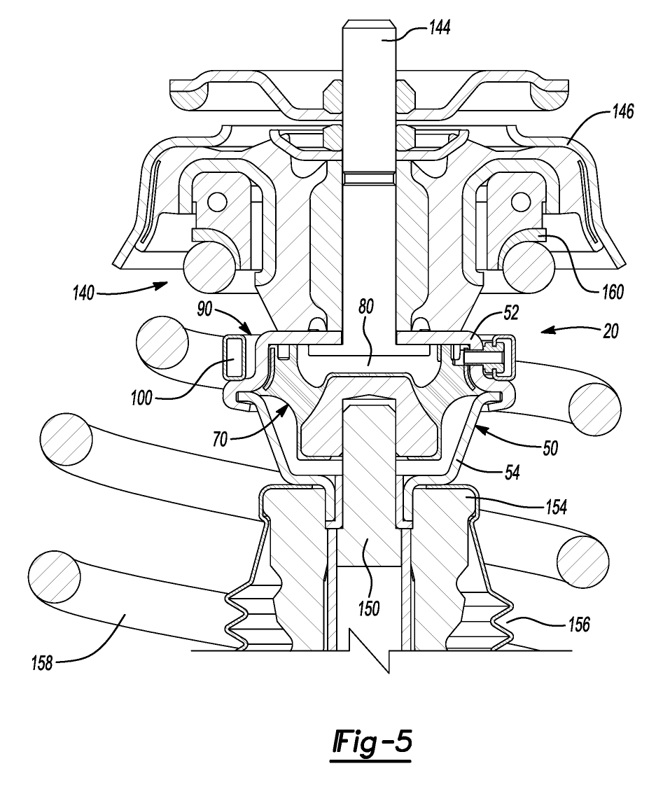

Referring to FIGS. 4-5, hydraulic element 20 is illustrated as a part of a strut top mount assembly for a vehicle suspension system. It should be understood that a hydraulic element according to the principles of the present disclosure can be used in a variety of vehicle applications. For example, a hydraulic element according to the principles of the present disclosure can be used as an engine mount or in an engine mount assembly. Accordingly, it should be understood that this exemplary description of hydraulic element 20 equally applies to other applications thereof.

Hydraulic element 20 is disposed between a top mount 140 and a strut 142. In particular, a rod segment 144 secured to top mount 140 is fixed to first housing component 52 of hydraulic element 20. Top mount 140 is further fixed to a vehicle frame component 146.

Strut 142 includes a strut rod 150 extending therefrom. Strut rod 150 extends through second housing component 54 of hydraulic element 20 and is fixed to spring assembly 70. A jounce bumper 154 and a dust boot 156 are also disposed on strut 142. Additionally, a coil spring 158 extends around strut 142 and engages a spring seat 160 of top mount 140.

Hydraulic element 20 is coupled in series for transmitting forces between top mount 140 and strut 142 and provides vibration absorbing functionality such as low amplitude hydraulic damping with decreased dynamic stiffness from that of typical strut behaviors. Such operation is well known to those of ordinary skill in the art and will not be described in further detail herein. Moreover, hydraulic element 20 provides for a relatively compact configuration of the strut mount assembly.

The present disclosure can vary in many ways. For example, a hydraulic element according to the principles of the present disclosure can be used in a variety of applications. As such, a hydraulic element according to the principles of the present disclosure can have a variety of configurations. Furthermore, the components of a hydraulic element according to the principles of the present disclosure can be made of and/or include a variety of materials and can have a variety of configurations. For example, an external component of a hydraulic element according to the principles of the present disclosure can have a variety of shapes and can be disposed in a variety of positions. Accordingly, it should be understood that the present disclosure is exemplary in nature.

What is claimed is:

1. A hydraulic element for a vehicle mount assembly, the hydraulic element comprising:
a housing adapted to be coupled between members of a vehicle;
a spring assembly disposed within said housing, said spring assembly engaging said housing so as to define a first chamber between said spring assembly and said housing; and
an external component disposed outside of said housing, said external component defining a second chamber therein, said second chamber being in fluid communication with said first chamber.

2. The hydraulic element of claim 1, wherein said external component is disposed adjacent said housing within a region bounded by a height of said housing.

3. The hydraulic element of claim 2, wherein said housing has a first component and a second component secured together, said external component being disposed within a region bounded by a height of said first component.

4. The hydraulic element of claim 1, wherein said external component has a generally annular shape, said external component being disposed around said housing.

5. The hydraulic element of claim 1, wherein said spring assembly has a track therein, said track being disposed between said first chamber and said second chamber and providing fluid communication therebetween.

6. The hydraulic element of claim 1, wherein said spring assembly has a concave portion therein, said first chamber being defined between said housing and said concave portion.

7. The hydraulic element of claim 1, further comprising a coupling member secured to said housing and said external component, said coupling member having a channel defined therethrough, said coupling member extending into said housing and said external component so that said channel provides fluid communication between said first and second chambers.

8. A mount assembly comprising:
a housing;
a first member fixed to said housing;
a spring assembly disposed within said housing, said spring assembly engaging said housing so as to define a first chamber between said spring assembly and said housing;
a second member fixed to said spring assembly opposite said first chamber, said second member extending through said housing; and
an external component disposed outside of said housing, said external component defining a second chamber therein, said second chamber being in fluid communication with said first chamber.

9. The mount assembly of claim 8, wherein said external component is disposed adjacent said housing within a region bounded by a height of said housing.

10. The mount assembly of claim 9, wherein said housing has a first component and a second component secured together, said external component being disposed within a region bounded by a height of said first component.

11. The mount assembly of claim 8, wherein said external component has a generally annular shape, said external component being disposed around said housing.

12. The mount assembly of claim 8, wherein said spring assembly has a track therein, said track being disposed between said first chamber and said second chamber and providing fluid communication therebetween.

13. The mount assembly of claim 8, wherein said spring assembly has a concave portion therein, said first chamber being defined between said housing and said concave portion.

14. The mount assembly of claim 8, further comprising a coupling member secured to said housing and said external component, said coupling member having a channel defined therethrough, said coupling member extending into said housing and said external component so that said channel provides fluid communication between said first and second chambers.

15. The mount assembly of claim 8, wherein said first member is a rod segment adapted to be coupled to a vehicle frame and said second member is a strut rod adapted to be coupled to a vehicle suspension system.

16. A vehicle suspension assembly comprising:
a vehicle frame adapted to support a body of a vehicle;
a strut top mount secured to said vehicle frame;
a rod segment secured to said strut top mount;
a strut rod adapted to be coupled to a vehicle suspension system; and
a hydraulic element coupled between said rod segment and said strut rod, said hydraulic element including:
a housing fixed to said rod segment,
a spring assembly disposed within said housing, said spring assembly engaging said housing so as to define a first chamber between said spring assembly and said housing, said strut rod fixed to said spring assembly opposite said first chamber, said strut rod extending through said housing, and
an external component disposed outside of said housing, said external component defining a second chamber therein, said second chamber being in fluid communication with said first chamber.

17. The vehicle suspension assembly of claim 16, wherein said external component is disposed adjacent said housing within a region bounded by a height of said housing.

18. The vehicle suspension assembly of claim 16, wherein said housing has a first component and a second component secured together, said external component being disposed within a region bounded by a height of said first component.

19. The vehicle suspension assembly of claim 16, wherein said external component has a generally annular shape, said external component being disposed around said housing.

20. The vehicle suspension assembly of claim 16, wherein said spring assembly has a track therein, said track being disposed between said first chamber and said second chamber and providing fluid communication therebetween.

21. The vehicle suspension assembly of claim 16, wherein said spring assembly has a concave portion therein, said first chamber being defined between said housing and said concave portion.

22. The vehicle suspension assembly of claim 16, further comprising a coupling member secured to said housing and said external component, said coupling member having a channel defined therethrough, said coupling member extending into said housing and said external component so that said channel provides fluid communication between said first and second chambers.
